(19) United States
(12) Patent Application Publication
(10) Pub. No.: US 2012/0162636 A1
(43) Pub. Date: Jun. 28, 2012

(54) PROXIMITY DETECTOR INCLUDING ANTI-FALSING MECHANISM

(75) Inventor: Alan Sy, Austin, TX (US)

(73) Assignee: SILICON LABORATORIES, INC., AUSTIN, TX (US)

(21) Appl. No.: 12/978,114

(22) Filed: Dec. 23, 2010

(51) Int. Cl. G01B 11/14; G01J 3/00

(52) U.S. Cl. 356/51; 356/614

(57) ABSTRACT

A proximity detector transmits light to an object near the proximity detector, thus providing transmitted light. A photo-sensor in the proximity detector receives transmitted light reflected by the object. The proximity detector tests the transmitted light reflected by the object to determine if the reflected light exceeds a predetermined brightness threshold value to provide preliminary object detection. The proximity detector confirms object detection by further testing ambient light received by the photo-sensor to determine if there is a substantial decrease in the amount of ambient light detected by the photo-sensor as the distance between the object and the proximity detector decreases.

### BACKGROUND

The disclosures herein relate generally to sensors, and more particularly, to proximity sensors that detect the presence of objects.

Early proximity sensors relied on ultrasonics to detect the presence of objects within a particular target field. These detectors typically included an ultrasonic transmitter and a corresponding ultrasonic receiver. The ultrasonic transmitted emitted a sound signal into the target field. If an object was present in the target field, the ultrasonic receiver received sound waves reflected by the object and generated an alert in response.

Proximity sensor devices have progressed in recent years and are now available in a miniaturized integrated circuit form. These modern proximity sensors may employ an infrared transmitter and an infrared receiver. The infrared transmitter emits infrared light into a target field. If an object is present in the target field, the infrared light reflects off the object and travels back to the infrared receiver. The proximity sensor generates an object detected signal when the object comes sufficiently close to the sensor to reflect light back to the infrared receiver.

### BRIEF SUMMARY

In one embodiment, a proximity detection method is disclosed. The method includes transmitting, by a proximity detector, light to an object near the proximity detector thus providing transmitted light. The method also includes detecting, by the proximity detector, transmitted light reflected by the object as exceeding a predetermined brightness threshold value, to provide preliminary object detection. The method further includes testing, by the proximity detector, to determine if there is a substantial decrease in an amount of ambient light detected by the proximity detector as the distance between the object and the proximity detector decreases to confirm object detection.

In another embodiment, a proximity detector is disclosed. The proximity detector includes a light source that transmits light to an object near the proximity detector thus providing transmitted light. The proximity detector also includes a sensor that detects transmitted light reflected by the object when the proximity detector operates in a proximity sensing (PS) mode, the sensor detecting ambient light when the proximity detector operates in an ambient light sensing (ALS) mode. The proximity detector further includes a controller that is coupled to the light source and the sensor. The controller determines if transmitted light reflected by the object exceeds a predetermined brightness threshold value thus providing preliminary object detection. The controller further determines if there is a substantial decrease in an amount of ambient light detected by the sensor as the distance between the object and the proximity detector decreases to confirm object detection.

In another embodiment, a portable communication device is disclosed. The portable communication device includes a transceiver that transmits and receives radio frequency signals. The portable communication device also includes a display that displays information and that receives user input. The portable communication device further includes a light source that transmits light to an object near the proximity detector thus providing transmitted light. The portable communication device still further includes a sensor that detects transmitted light reflected by the object when the proximity detector operates in a proximity sensing (PS) mode, the sensor detecting ambient light when the proximity detector operates in an ambient light sensing (ALS) mode. The portable communication device also includes a controller, coupled to the light source, the sensor and to the display, the controller determining if transmitted light reflected by the object exceeds a predetermined brightness threshold value thus providing preliminary object detection. The controller further determines if there is a substantial decrease in an amount of ambient light detected by the sensor as the distance between the object and the proximity detector decreases to confirm object detection.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 is a block diagram of one embodiment of the disclosed proximity sensor system.

FIG. 2A is a block diagram of one embodiment of the disclosed proximity detector shown sensing a small object.

FIG. 2B is a block diagram of one embodiment of the disclosed proximity detector shown sensing a large object.

FIG. 2C is a block diagram of one embodiment of the disclosed proximity detector shown sensing a small object when the small object closely approaches a sensor.

FIG. 2D is a block diagram of one embodiment of the disclosed proximity detector shown sensing a large object when the large object closely approaches the sensor.

FIG. 3 is a timing diagram showing the on/off states of a light source in the proximity detector when the detector alternates between proximity sensing measurements and ambient light measurements.

FIG. 4A is a graphical representation of reflected light measurements as a function of time during a proximity sensing (PS) mode in the disclosed proximity detector.

FIG. 4B is a graphical representation of ambient light measurements as a function of time during an ambient light sensing (ALS) mode in the disclosed proximity detector.

FIG. 4C is a graphical representation of both reflected light measurements as a function of time during the proximity sensing (PS) mode and ambient light measurements as a function of time during the ambient light sensing (ALS) mode in the disclosed proximity detector.

FIG. 5 is a block diagram of a portable communication device using the disclosed proximity sensor system to control activation of a display screen.

FIG. 6 is a block diagram of another embodiment of a portable communication device using the disclosed proximity sensor system to control activation of a display screen.

FIG. 7 is a flowchart of a simplified process flow for the disclosed proximity detector.

FIG. 8 is a flowchart of a more detailed process flow for the disclosed proximity detector.

### DETAILED DESCRIPTION

In one embodiment, the disclosed proximity detector operates in a proximity sensing mode and an ambient light sensing mode to determine when an object approaches the detector. In the proximity sensing mode, the detector bounces light off an approaching object and detects the presence of the object by receiving light reflected from the object. In one embodiment, upon initial detection of the object, the proximity detector may switch to operation in an ambient light sensing mode. The ambient light sensing mode confirms the presence of a relatively large object when the object approaches sufficiently close to the proximity detector to block a substantial amount of ambient light from reaching the proximity detector. In this manner, the disclosed proximity detector may reduce false or unintended detection of small objects for which detection may not be desired. The ambient light sensing mode effectively confirms the size of the object as being sufficiently large to block a substantial portion of the ambient light from the proximity detector when the object is close to the proximity detector. Small objects may not produce substantial blocking of ambient light. Thus, falsing on small objects, such as a user's fingers for example, may be effectively reduced when detection of larger objects, such as a user's head for example, is desired.

In one embodiment, the disclosed proximity detector may alternate between proximity sensing mode and ambient light sensing mode as it detects and confirms the presence of an approaching object. The proximity detector may employ one wavelength band of light, such as infrared light, for the proximity sensing mode and another wavelength band of light, such as visible light, in the ambient light sensing mode. Alternatively the same wavelength band, such as infrared light, may be used for both the proximity sensing mode and the ambient light sensing mode. While the teachings below generally refer to the proximity detector moving toward the object, such motion is relative. Thus, the teachings apply as well to scenarios wherein the object is moving toward the proximity detector.

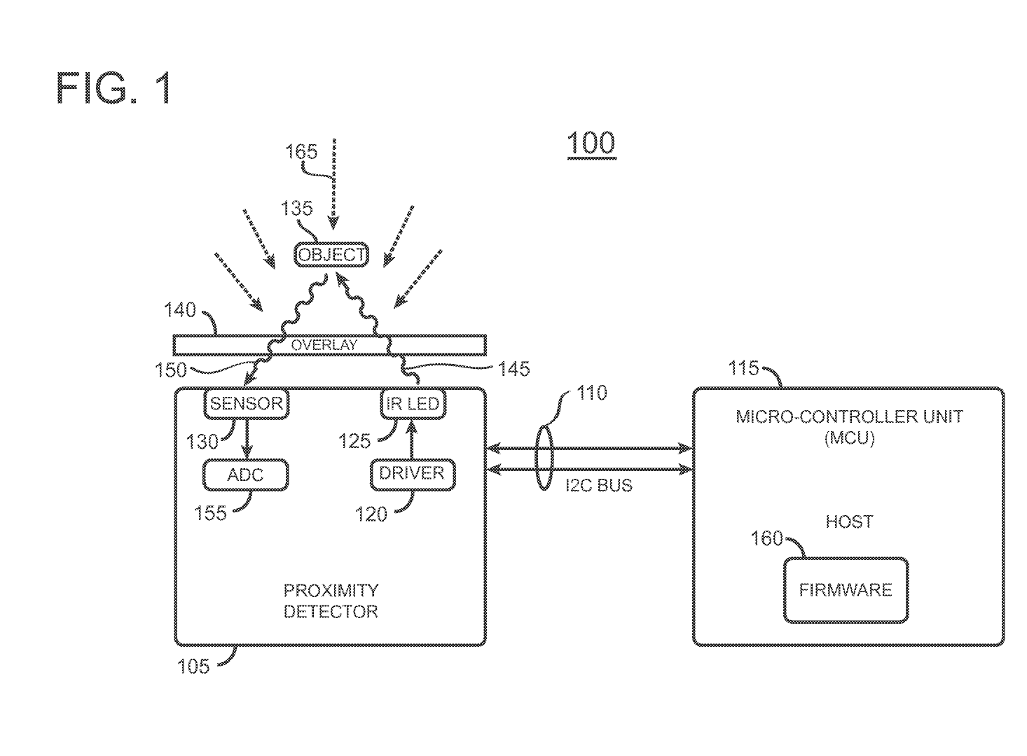

FIG. 1 is a block diagram of one embodiment of the disclosed proximity sensor system 100. Proximity sensor system 100 includes a proximity detector 105 that couples via a communication bus 110 to a micro-controller unit (MCU) 115. In one embodiment, an 120 bus may be employed as communication bus 110 although other busses may be used as well depending on the particular application. MCU 115 acts as host that controls the operation of proximity detector 105. MCU 115 configures proximity detector 105, as described in more detail below. Proximity detector 105 may be implemented in integrated circuit (IC) form, although discrete implementations using printed circuit boards are also possible.

Proximity detector 105 includes a driver 120 that excites an infrared (IR) LED 125 to generate IR light when instructed by MCU 115. In actual practice, IR LED 125 may be external to proximity detector 105 when proximity detector 105 is implemented in integrated circuit form. A light sensor 130 or photo sensor such as a photodiode is situated adjacent IR LED 125 to receive IR light reflected from a nearby object 135. A transparent overlay 140 is situated adjacent proximity detector 105 to provide a protective covering for light sensor 130.

Object 135 is located in a target field near proximity detector 105. IR LED 125 generates incident light 145 that reflects off object 135 as reflected light 150 when object 135 approaches proximity detector 105 in the target field. Light sensor 130 receives the reflected light 150. As object 135 comes closer and closer to light sensor 130, the brighter the reflected light signal perceived by sensor 130 becomes. An analog to digital converter (ADC) 155 couples to light sensor 130. ADC 155 generates a detection count that is higher the brighter the reflected light 150 becomes. In other words, the detection count that ADC 155 generates varies directly with the intensity of the reflected light 150 that light sensor 130 receives. High intensity reflections result in high detection counts from ADC 155 whereas low intensity reflections result in lower detection counts from ADC 155. Higher detection counts signify that the object is closer to the sensor 150 than lower detection counts. The intensity of the reflected light 150 varies with the reflectivity of object 135. Human skin exhibits higher reflectivity than human hair and thus results in higher intensity reflections and higher detection counts at the same distance from light sensor 130.

In one embodiment, light sensor 130 exhibits a sufficiently wide response range or bandwidth to be sensitive to both infrared light generated by IR LED 125 and ambient light in the visible spectrum. System 100 commences operation by initializing MCU 115 and proximity detector 105. Firmware 160 governs the operation of MCU 115 as MCU 115 controls the operation of proximity detector 105.

After initialization with MCU 115 being configured as a host, MCU 115 instructs proximity detector 105 to commence operation in proximity sensing (PS) mode. In response, proximity detector 105 begins operation in proximity sensing mode to detect the presence of object 135 if present in the target field. MCU 115 instructs proximity detector 105 to turn on IR LED 125 to generate incident light 145. Incident light 145 impinges on, and reflects from, object 135 if object 135 is within the target field adjacent proximity detector 105. Sensor 130 receives the resultant reflected light 150, and in response, ADC 155 generates a detection count or ADC count value that corresponds to the intensity of the received reflected light.

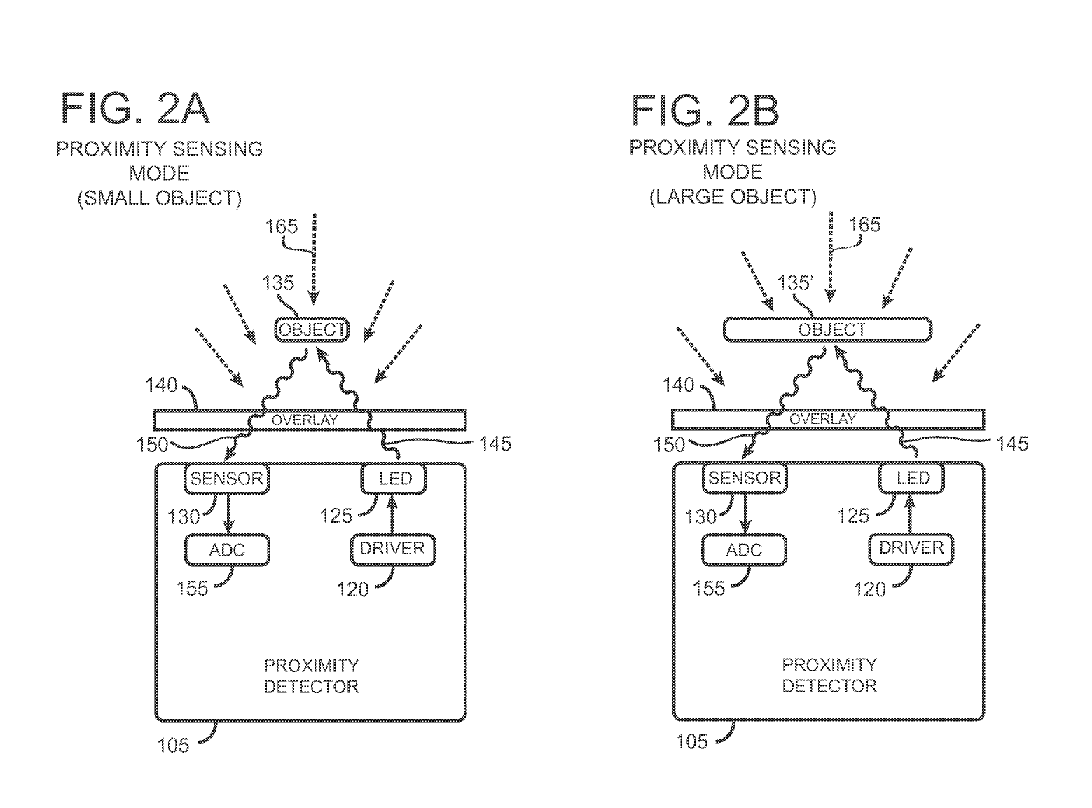

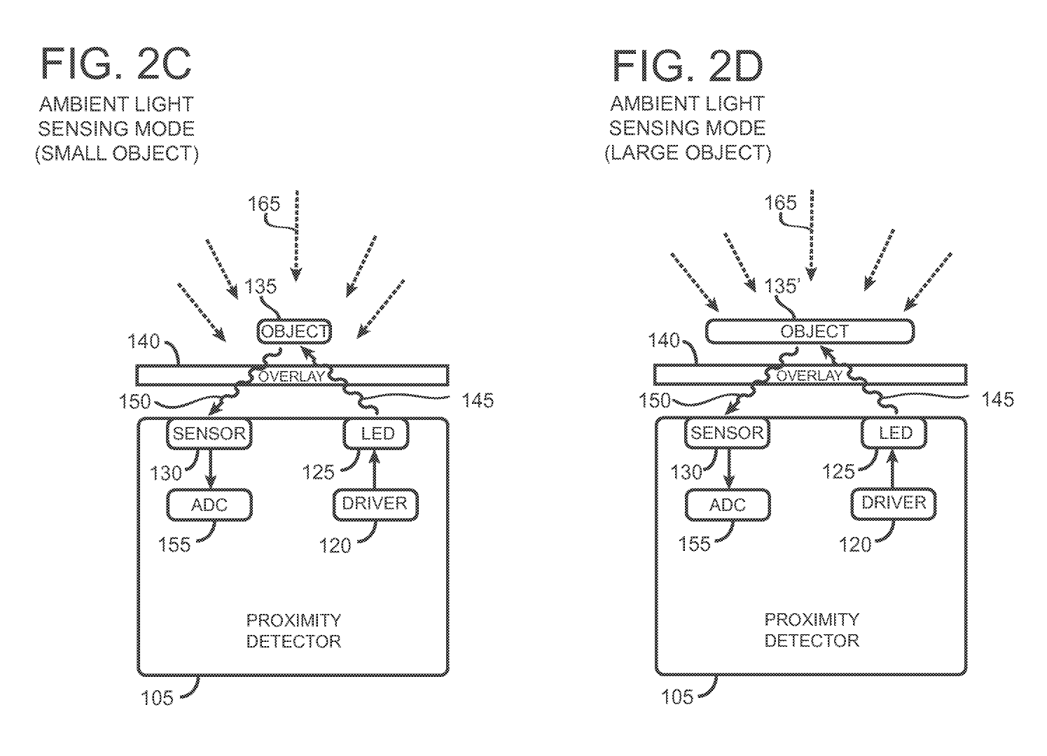

In one embodiment, MCU 115 configures proximity detector 105 with a predetermined detection threshold that, when exceeded, indicates the presence of object 135 in the target field. In other words, if the detection count of ADC 155 for reflected light 150 from a particular object 135 exceeds the predetermined detection threshold, then the proximity sensing (PS) mode of proximity detector 105 indicates the presence of the object. This represents a preliminary conclusion that an object is present because proximity detector 105 has not yet entered ambient light sensing (ALS) mode to confirm the presence of an object of desired size, for example a relatively large object such as a human head or cheek. In other words, system 100 has detected the presence of on object, but has not yet discerned whether the object is a relatively small object 135, such as shown in FIG. 2A, or a relatively large object 135′ such as shown in FIG. 2B. In FIGS. 1, 2A and 2B, wavy lines with arrows indicate incident light 145 and reflected light 150, whereas dashed lines with arrows such as line 165 indicate ambient light from light sources other than LED 125.

In one embodiment, after performing the initial detection of an object in proximity sensing (PS) mode, MCU 115 instructs proximity detector 105 to switch to ambient light sensing (ALS) mode. In ambient light sensing (ALS) mode, system 100 determines whether the object is a small object 135, such as shown in FIG. 2C, or a large object 135′ such as shown in FIG. 2D. Proximity detector 105 turns LED 125 on during proximity sensing (PS) mode and off during ambient light sensing (ALS) mode. In actual practice, proximity detector 105 may switch repeatedly back and forth between proximity sensing mode and ambient light sensing mode as an object 135 comes closer and closer to proximity detector 105. In that scenario, proximity detector 105 collects a number of ADC counts while in proximity sensing (PS) mode and collects a number of ADC counts while in ambient light sensing (ALS) mode. These ADC counts are stored in a memory for later processing, as discussed in more detail below.

When a relatively large object, such as object 135′ of FIG. 2D, approaches proximity detector 105, there is a substantial decrease in the ADC count that ADC 155 generates. This occurs because a large object such as the user's head blocks a significant portion of the ambient light 165 as that large object approaches sensor 130. Small objects such as the user's fingers do not block a significant portion of ambient light 165 and thus a substantial drop in the count that ADC 155 generates does not occur. As object 135′ approaches sensor 130, MCU 115 monitors the ADC count and tests the ADC count for a substantial decrease in the count. In one embodiment, a 50% decrease in the ADC count corresponds to a substantial decrease in ADC count. ADC count decreases of other than a 50% decrease may also be used as a substantial decrease in ADC count depending on the particular application, as long as the decrease corresponds to a blocking of a substantial portion of the ambient light that would otherwise impinge on sensor 130.

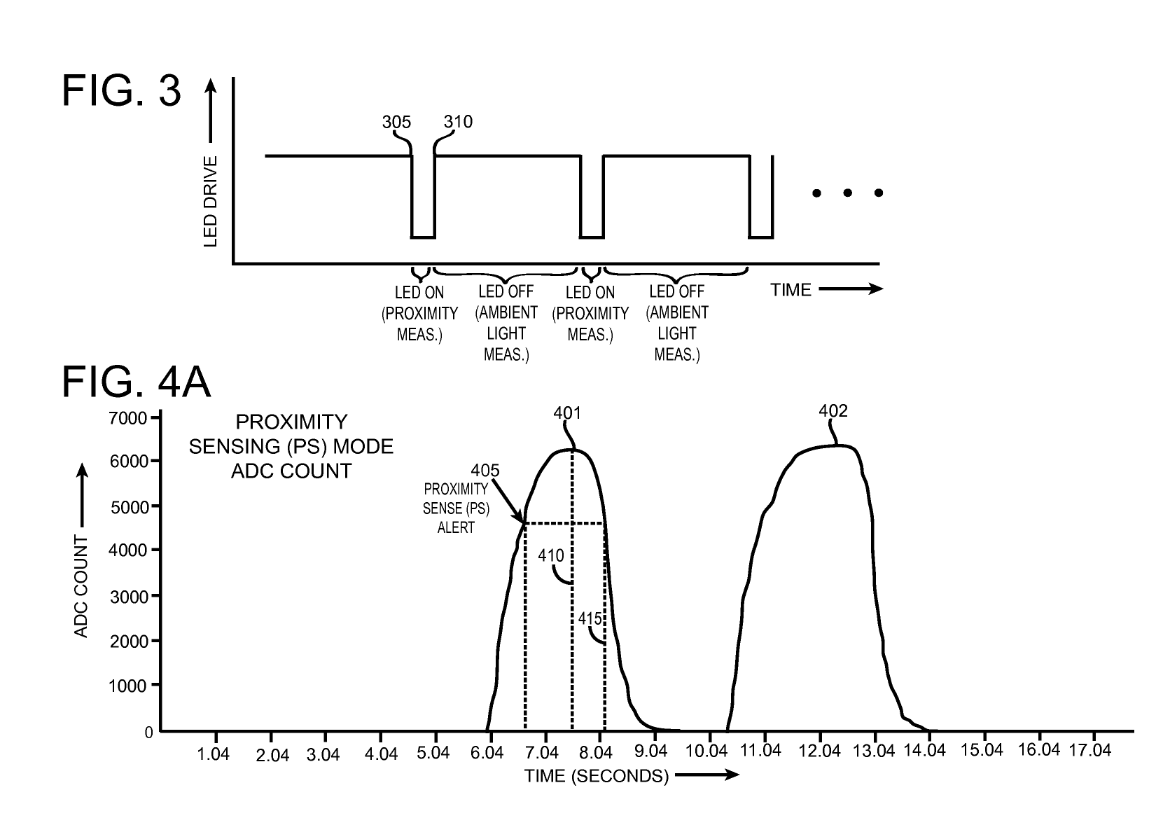

FIG. 3 is a graphical representation of an LED drive signal for LED 125 vs. time. FIG. 3 shows time periods when LED 125 is alternately on and off. More specifically, the LED ON period designates when the LED is on during proximity measurement in proximity sensing (PS) mode. The LED OFF period designates when LED 125 is off during the ambient light measurement of ambient light sensing (ALS mode. The LED drive signal transitions from logic high to logic low at 305 to commence the LED ON period of proximity sensing (PS) mode. The LED drive signal transitions from logic low to logic high at 310 to commence the LED OFF period of ambient light sensing mode.

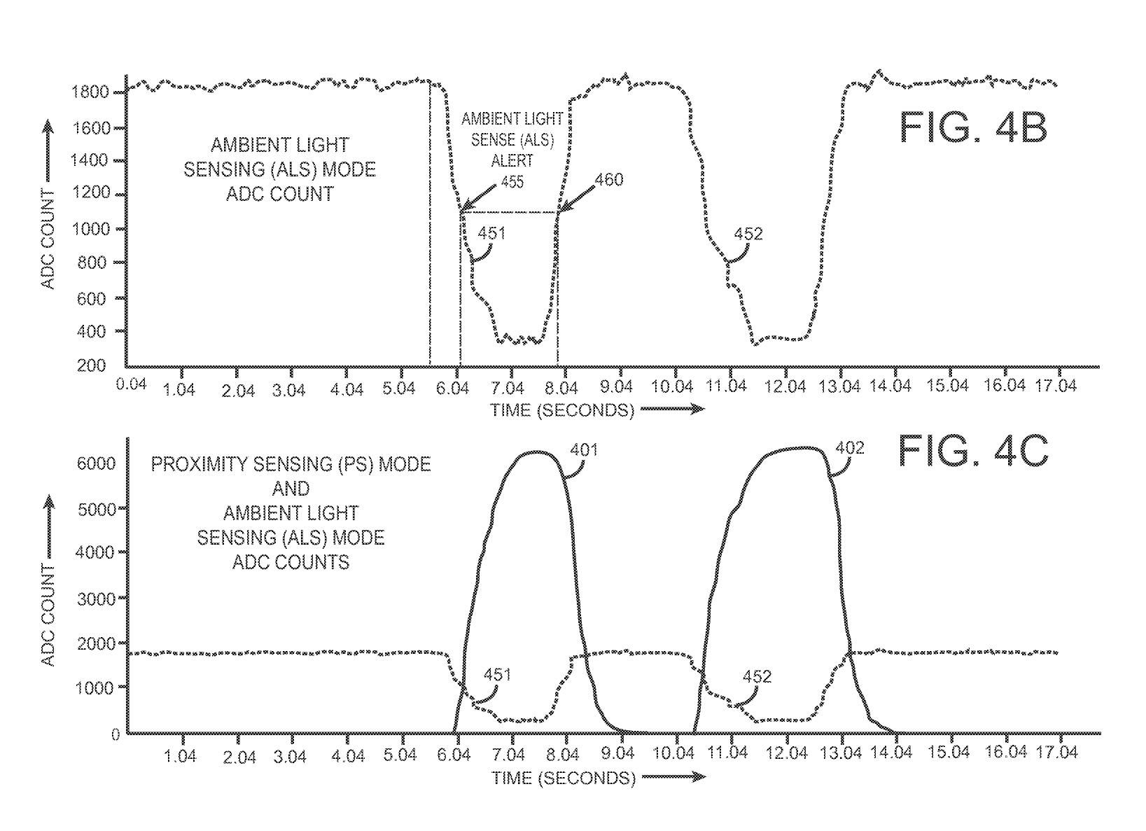

FIG. 4A is a representation of ADC count vs. time in proximity sensing (PS) mode that illustrates threshold setting and detection points of proximity detector 105 when proximity detector 105 is used to detect the presence of the human head or cheek. The values of ADC count and time discussed below with respect to FIG. 4A are given for example purposes and should not be taken in any way as being limiting. Other ADC values and time values will achieve acceptable results as well depending on the particular application. The curve plotted in FIG. 4A represents raw ADC count data from ADC 155 for the proximity sensing (PS) mode. Over time, proximity detector 105 takes a series of reflected infrared light measurements, turning the IR LED 125 on for each measurement in PS mode. Proximity detector 105 stores these ADC count measurements in a memory, as discussed below in more detail. These ADC count measurements over time represent IR light reflected from the object and form the curves 401 and 402 shown in FIG. 4A. More particularly, FIG. 4A shows an ADC count curve 401 that proximity detector 105 generates when detector 105 approaches an object and moves away from the object. FIG. 4A also shows an ADC count curve 402 that proximity detector 105 generates when detector 105 again approaches an object and moves away from the object.

In more detail, at a time equals zero to time equals approximately 5.9 seconds, the ADC count is zero which indicates that the object is not within a predetermined minimum sensing distance or target field of proximity detector 105. In other words, proximity detector 105 receives no significant reflected light from the object in PS mode until reaching this predetermined minimum sensing distance. Proximity detector 105 starts to receive reflected light from the object when the time is greater than 5.9 seconds. When proximity detector 105 continues to approach the object, the ADC count rises as more and more infrared light reflects back to sensor 130 in PS mode. As proximity detector 105 continues to approach the object, detector 105 comes sufficiently close to the object that the ADC count reaches a proximity sense (PS) alert threshold value, for example 4700, at PS alert point 405. This signifies that proximity detector 105 has detected an object within the target field. In one embodiment wherein the object intended to be detected is a human head or cheek, the PS alert threshold value may be selected to correspond to the ADC count value that ADC 155 generates when the distance between the proximity detector and human skin is approximately 7 cm. This threshold may be adjusted according to the particular sensing distance desired between the object and the proximity detector 105 for preliminary detection to occur. Black hair is more infrared absorbent than human skin; however, black hair does reflect about 15% of infrared light. If desired, the threshold may be adjusted, i.e. decreased, to enable the proximity detector to trigger on black hair at a predetermined sensing distance.

As proximity detector 105 continues to approach the object, the measured ADC values continue to rise and reach a peak at a time equal to approximately 7.5 seconds, as indicated by dashed line 410. After this point in time, proximity detector 105 moves away from the object and the ADC count decreases until the ADC count is less than the 4700 ADC count proximity sense (PS) threshold at dashed line 415 for time equals 8.1 seconds. When the proximity detector moves beyond the position corresponding to the PS sense alert threshold, proximity detector 105 discontinues the alert, thus signifying that the object is no longer detected as being in the target field. The ADC count continues to decrease further as the proximity detector 105 moves even further away from the object until reaching zero at approximately 9.1 seconds in this particular example.

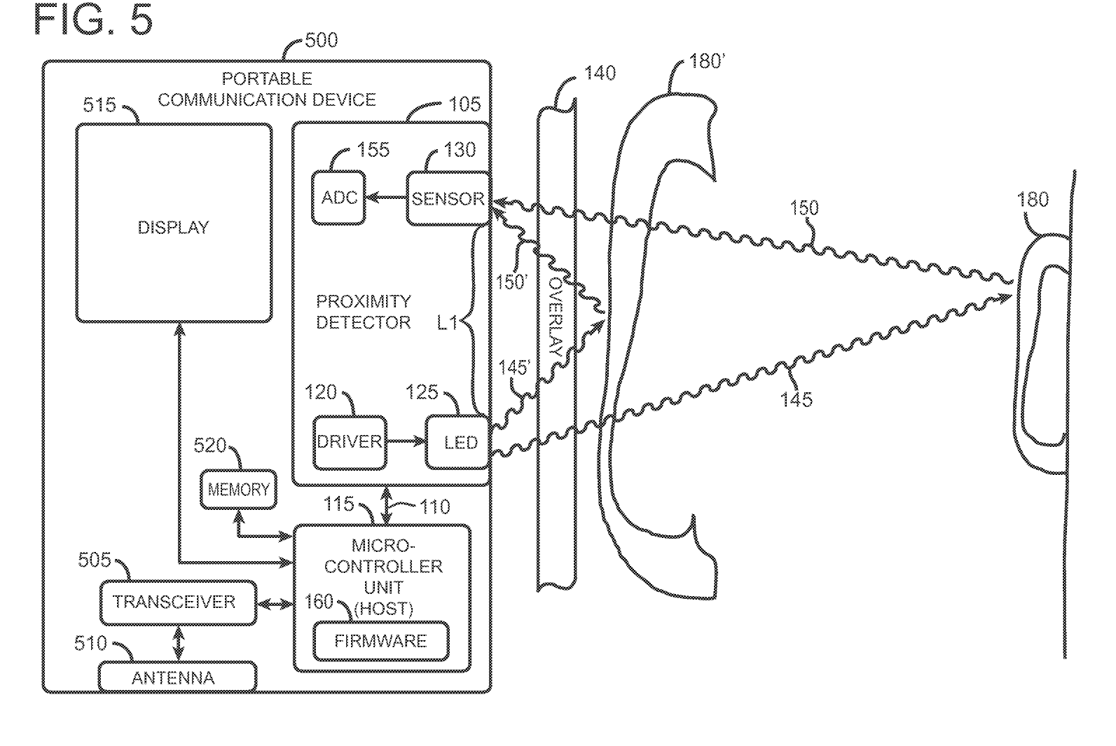

FIG. 4B is a representation of ADC count vs. time in ambient light sensing (ALS) mode that illustrates threshold setting and detection points of proximity detector 105 when proximity detector 105 is used to detect the presence of the human head or cheek. While proximity detector 105 is taking the proximity sensing (PS) mode measurements that FIG. 4A depicts, proximity detector 105 is also taking ambient light sensing (ALS) mode measurements that FIG. 4B depicts. In one embodiment, proximity detector 105 takes PS mode measurements and ALS mode measurements, one after the other in alternating fashion. Proximity detector 105 stores these ADC count measurements in a memory such as memory 520 of FIG. 5.

When proximity detector 105 commences taking ALS mode ADC count measurements at time zero, infrared LED 125 is off, and thus any light that may be sensed by sensor 130 is ambient light. In the particular example depicted in FIG. 4B, ambient ADC count values exhibit approximately 1800 counts from time zero to time equals 5.7 seconds. If the object is a relatively large object such as a head or cheek, as the proximity detector 105 moves toward the object, the objects starts to block ambient light from reaching sensor 130. Thus, the ambient light sensed by sensor 130 decreases such as seen in FIG. 4B between time equals approximately 5.5 seconds and approximately 7.6 seconds. If the object is a relatively small object such as a finger, then the object has little impact on ambient light levels sensed by sensor 130. However, FIG. 4B depicts the scenario wherein proximity detector 105 detects a relatively large object. When the ambient light level, as measured by ADC count, decreases by approximately 50% (e.g. from an ADC count of 1800 to an ADC count of approximately 900 in this particular example), then ambient light is found to have decreased by a substantial amount to an ambient light sense (ALS) alert threshold or point 455. Reaching the ALS alert threshold in ALS mode confirms that the object preliminarily detected in PS mode is a relatively large object such as a human head or cheek. In response to this detection and confirmation in ALS mode, MCU 115 may take an action such as turning off the display 515 of a portable communication device 500, as discussed below with reference to FIG. 5.

After coming sufficiently close to the object to reach the ALS alert 455, the proximity detector 105 continues coming closer to the object until the ADC count reaches a minimum value of approximately 300, in this particular example, between time equals approximately 6.8 seconds and time equals approximately 7.6 seconds. From time equals approximately 7.6 seconds to time equals 8.2 seconds the ADC count increases, thus indicating that the proximity detector 105 is now moving away from the object. When the ADC count increase sufficiently to rise beyond the ALS alert threshold value at 460, then proximity detector 105 releases the ALS alert and, in response, MCU 115 may take action such as turning display 515 back on. In this manner, ADC count curve 451 is formed as the relatively large object approaches and then moves away from the proximity detector. Another sample ADC count curve is shown as ADC count curve 452 which also depicts the ADC count as another relatively large object approaches and then moves away from the proximity detector.

FIG. 4C superimposes the proximity sensing (PS) mode curve of FIG. 4A on the ambient light sensing (ALS) mode curve of FIG. 4B for comparison purposes. FIG. 4C shows that, for a relatively large object, the ADC PS count curve 401 of FIG. 4A corresponds in time approximately to the ADC ALS count curve 451 of FIG. 4B. In other words, for a large object, while the ADC PS count is generally increasing for IR light generated by LED 125 as the proximity detector and object come closer together, the ADC ALS count is generally decreasing for ambient light that sensor 140 senses as the proximity detector and object come closer together. For a small object, such as a finger, the ADC PS count may increase as proximity detector 105 moves closer to the object, but due to its small size, the finger object may have little impact on the ADC ALS count as the proximity detector 105 moves closer to the object. Continuing forward in time, in the portion of the graph of FIG. 4C where the proximity detector and large object are moving apart between time equals 7.6 seconds and time equals 9.1 seconds, the ADC PS count is generally decreasing for IR light generated by LED 125 and the ADC ALS count is generally increasing for ambient light that sensor 140 senses.

FIG. 5 is a block diagram of a portable communication device 500 that employs the disclosed proximity detector 105 wherein proximity detector 105 and microcontroller unit (MCU) 115 are physically distinct structures. For example, proximity detector 105 and MCU 115 may fabricated as separate integrated circuits (ICs). When comparing proximity detector 105 of FIG. 5 with proximity detector 105 of FIG. 1 and FIGS. 2A-2D, like numbers indicate like elements. MCU 115 couples to proximity detector 105 via bus 110. MCU 115 also couples to a radio frequency transceiver 505. Transceiver 505 may be configured for cellular telephone communication, trunking communication or may employ other communication protocols as well. Transceiver 505 couples to an antenna 510 that exhibits dimensions suitable for the transmit and receive frequencies that transceiver 505 employs. In one embodiment, portable communication device 500 may be configured as a so-called smart-phone that employs a display 515 to receive user input and to output display items to the user. For example, display 515 may be an LED touch screen display. When this is the case, it is desirable that MCU 115 turn on display 515 when communication device 500 is distant from the users' head or ear such as the case of ear 180 in FIG. 5, but turn off or disable display 515 when communication device 500 is immediately adjacent the ear such as indicated by ear 180′ in FIG. 5.

Under the direction of firmware 160, MCU 110 controls the operation of proximity detector 105 when proximity detector 105 employs proximity sensing (PS) mode and ambient light sensing (ALS) mode to detect and confirm the presence of an object. In one embodiment, firmware 160 directs proximity detector 105 to detect the presence of a relatively large object such as ear 180, but to not detect the presence of a relatively small object such as a finger. Detecting a small object such as a finger may be regarded as “falsing” or a false detection and is not desirable in one embodiment. The designation ear 180 indicates the ear as proximity detector 105 starts to move toward the object from some distance away from object, or vice versa. Under these conditions, light beam 145 is an incident beam that impinges on ear 180 and reflects back to proximity detector 105 as reflected beam 150. The designation ear 180′ indicates the same ear except that the ear is now in a position immediately adjacent proximity detector 105, as illustrated in FIG. 5. Under these conditions, light beam 145′ is an incident beam that impinges on ear 180′ and reflects back to proximity detector 105 as reflected beam 150′.

As communication device 500 moves closer and closer to ear 180, or vice versa, proximity detector 105 takes a series of proximity sensing (PS) mode readings of the ADC count and a series of ambient light sensing (ALS) mode readings of the ADC count. MCU 115 stores the ADC count readings or values of the proximity mode in a memory 520. MCU 115 also stores the ADC count readings or values of ambient light mode in memory 520. MCU 115, under the control and direction of firmware 160, examines the stored ADC count values of the proximity sensing (PS) mode to preliminarily detect the presence of the object within a target field near proximity detector 105. MCU 115, under the direction of firmware 160, further examines the stored ADC count values of the ambient light sensing (ALS) mode as the proximity detector 105 comes closer and closer to object 180. When MCU 115 observe a substantial decrease in the ADC count in ambient light sensing (ALS) mode, for example an approximately 50% decrease in the ADC count, this indicates that a relatively large object is causing substantial blocking of ambient light to sensor 130. This decrease in the ADC count confirms that a relatively large object such as ear 180′ is now immediately adjacent proximity detector 105. Upon detection and confirmation of the presence of object 180′ immediately adjacent proximity detector 105, MCU 115 instructs touch screen display 515 to turn off to conserve power and to prevent contact with the user's ear from providing unintended input to touch screen display 615. This effectively disables user input to display 515 and may reduce falsing by unintended small objects such as fingers. Rather than turning off display 515, MCU may disable display 515 to conserver power and prevent unintended user input under the above-described circumstances.

MCU 115 continues to monitor the ADC count. When the user moves device 600 away from object 180′, or vice versa, the ADC count in ambient light sensing (ALS) mode substantially rises, the ADC count of the proximity sensing (PS) mode substantially decreases, and MCU instructs display 515 to turn back on in response to one of, or both of, these events. This effectively re-enables user input to the display 515. MCU 115 returns to monitoring the ADC values of proximity sensing (PS) mode and the ADC values of ambient light sensing (ALS) mode as before and the proximity sensing process continues.

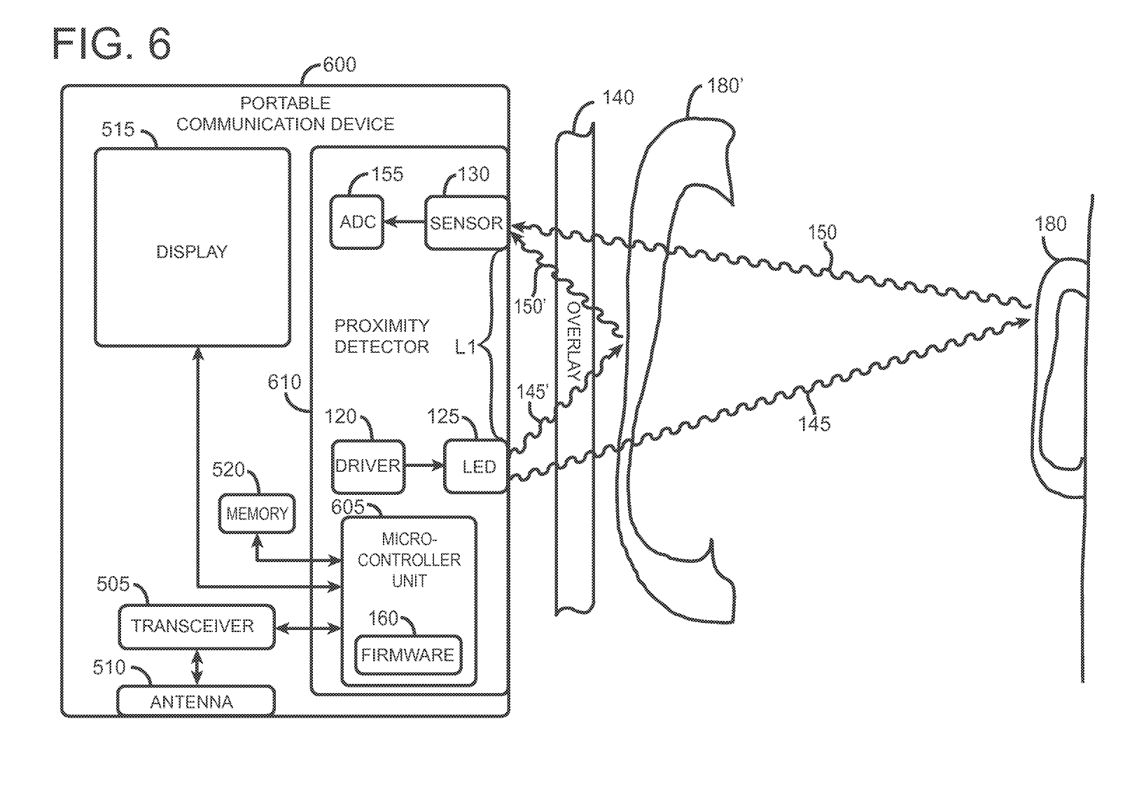

FIG. 6 is a block diagram of a portable communication device 600. Portable communication device 600 is similar to portable communication device 500 of FIG. 5 with like numbers indicating like elements. However, in portable communication device 600, the proximity detector and micro-controller unit 605 are situated in a common integrated circuit 610. Sensor 130 and LED 125 may be external to integrated circuit 610.

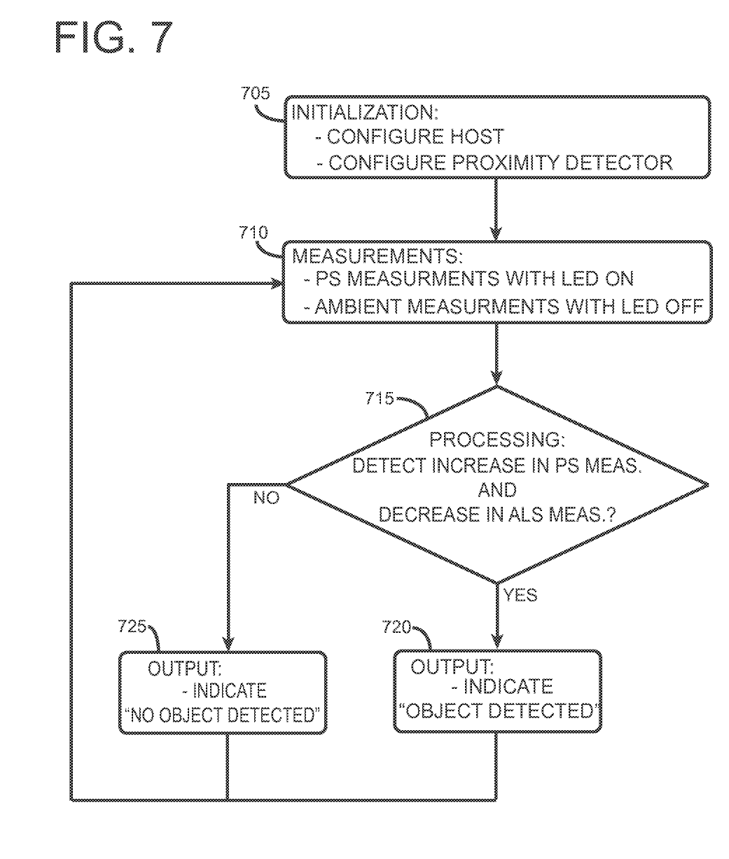

FIG. 7 is a flowchart of a simplified process flow for the disclosed proximity sensor system. In one embodiment, firmware 160 implements this process flow. Microcontroller unit (MCU) 115 is configured as a host that it capable of communicating with proximity detector 105 via bus 110, as per block 705. Proximity detector 105 is configured to receive commands from MCU 115. Proximity detector 105 performs a series of proximity sensing (PS) mode measurements over a predetermined period of time to determine ADC count values, as per block 710. During this time period, proximity detector 105 and an object 135 may move closer together, further apart or remain stationary. In one embodiment, during substantially the same period of time as the PS mode measurements were taken, proximity detector 105 performs a series of ambient light sensing (ALS) mode measurements to determine ADC count values, as per block 710. Proximity detector 105 or MCU 115 stores both the PS mode measurements and the ALS mode measurements in a memory for later processing.

Assume for discussion purposes that proximity detector 105 and the object 135 are moving closing together. In this case, either proximity detector 105 is moving toward object 135 or object 135 is moving toward proximity detector 105. Either way, as the distance between proximity detector 105 and object 135 decreases, the reflected IR light that sensor 130 senses from object 135 in PS mode increases. When MCU 115 determines that the ADC count value of the PS mode measurements exceeds the PS alert threshold of the proximity sensing (PS) mode, this signifies that proximity detector 105 has preliminarily detected the presence of object 135 within the target field. In response to detecting the presence of object 135, MCU 115 processes the ADC count values of the ambient light sensing (ALS) mode measurements to determine if there has been a substantial decrease in these ADC count values from a base line value. In one embodiment, an approximately 50% decrease in the ADC values is considered to be substantial. When MCU 115 determines such as 50% decrease in the ADC count values of ALS mode, this signifies that the object 135 is sufficiently large to block light a substantial portion of ambient light from reaching sensor 130 as object 135 and proximity sensor 105 come closer together. In other words, this confirms that a relatively large object 135 is present immediately adjacent proximity detector 105.

Both the detection of a rise in the ADC count values of the PS mode and the substantial decrease in the ADC count values of the ALS mode are performed by test block 715. If test block 715 determines both a substantial rise in the ADC count values of PS mode and a substantial decrease in the ADC count values of ALS mode, then MCU 115 outputs an indication of “objected detected”, as per block 715. However, if test block 715 fails to determine that there is both a substantial increase in the ADC count values of PS mode and a substantial decrease in the ADC count values of ALS mode, then MCU 115 outputs in indication of “no objected detected”, as per block 720.

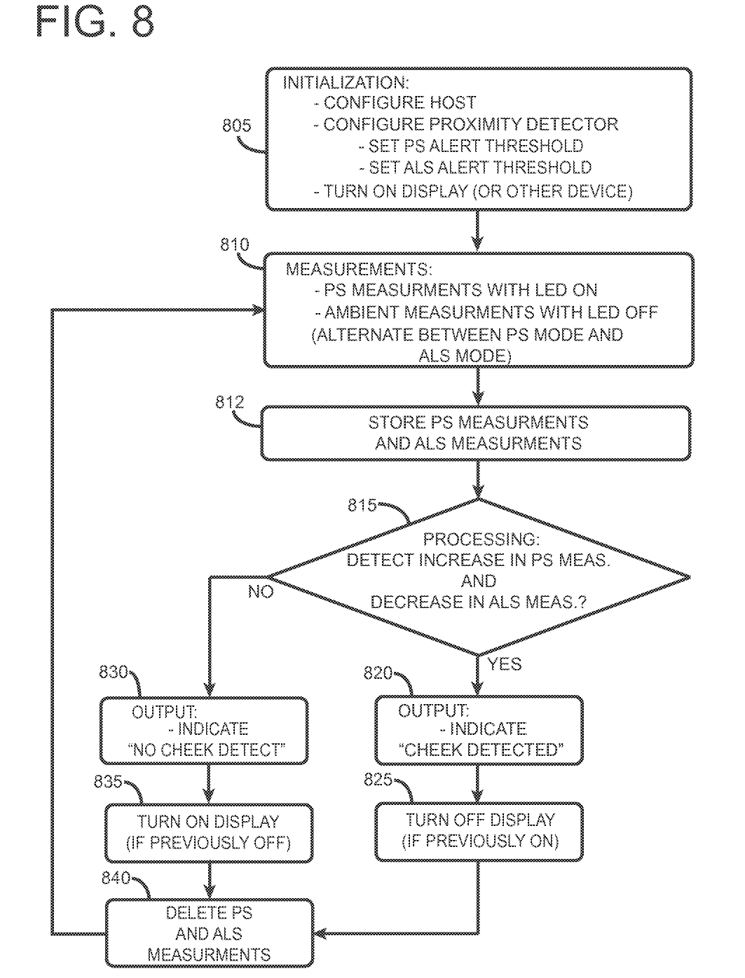

FIG. 8 is a more detailed flowchart of a representative process flow that portable communication device 500 may implement to practice the disclosed methodology. MCU 115 initializes and is configured as a host, as per block 805. MCU 115 uses bus 110 to configure proximity detector 105. More particularly, MCU 115 sets the PS alert threshold to a predetermine ADC count value that corresponds to sensor 130 detecting an object such as ear 180 within a particular target field at a particular distance from sensor 130 assuming a predetermined amount of reflectivity of the ear's skin. MCU 115 also sets the ALS alert to a predetermined threshold value that corresponds to a substantial decrease in the ADC count value to indicate that the detected object is sufficiently large to block a significant portion of ambient light from reaching sensor 130. As part of initialization, MCU 115 turns on display 515 to enable display 115 to output information and to accept input from the user, as per block 805.

Proximity detector 105 performs a series of proximity sensing (PS) mode measurements over a predetermined period of time to determine ADC count values, as per block 810. These PS mode measurements are performed with IR LED 125 turned on. During this predetermined time period, proximity detector 105 and an object 135 may move closer together. In one embodiment, during substantially the same time period as when the PS mode measurements are taken, proximity detector 105 performs a series of ambient light sensing (ALS) mode measurements to determine ADC count values. For each ALS mode measurement, the IR LED 125 is turned off to enable sensing of ambient light. Proximity detector 105 may alternate back and forth between sensing an ADC count in PS mode and sensing an ADC count in ALS mode while determining ADC values in the predetermined time period. MCU 115 retrieves these measured ADC values from proximity detector 105 and stores both the ADC values for the PS mode measurements and the ADC values for the ALS mode measurements in a memory 520 for later processing, as per block 812.

MCU 115 conducts a test at decision block 815 to determine if there is a substantial increase in the ADC count values of the PS mode measurements to exceed the PS sense alert threshold value that is calibrated to correspond to presence of an object in the target field. Upon detecting the presence of object 135, MCU 115 tests further and processes the ADC count values of the ALS mode measurements to determine if there has been a substantial decrease in these ADC count values from a base line ADC count value. In one embodiment, an approximate 50% decrease in the ADC value is considered to be substantial. When MCU 115 determines such as 50% decrease in the ADC count values of ALS mode, this means that the detected object is sufficiently large to block light a significant portion of ambient light from reaching sensor 130 as the object and proximity sensor 105 come closer together. In other words, this confirms that a relatively large object, such as the cheek or ear 180′ of the user, is present immediately adjacent proximity detector 105. When this occurs, MCU 115 outputs a “CHEEK DETECTED” indication, as per block 820. MCU 115 instructs display 515 to turn off if it was previously on, as per block 825. In this event, display 515 no longer provides display output and no longer accepts user input. This action conserves power and reduces the likelihood of falsing by relatively small objects such as the user's fingers coming close to display 515 and proximity detector 105. MCU 115 deletes the ADC counts of the PS and ALS measurements in memory 520, as per block 840, and process flow continues back to 810 where measuring of ADC counts is continued again in PS mode and ALS mode. However, if at decision block 815 MCU 115 does not determine that there is both a substantial increase in the ADC count of the PS mode measurements and a corresponding substantial decrease in the ADC count of the ALS mode, then MCU 115 outputs a “NO CHEEK DETECT” indication, as per block 830. MCU 115 turns display 515 on if it was previously off, as per block 835. MCU 115 deletes the ADC counts of the PS and ALS measurements in memory 520, as per block 840, and process flow continues back to 810 where measuring of ADC counts is continued again in PS mode and ALS mode.

In this manner, the number of false detects that a proximity detector may generate for relatively small objects may be significantly reduced. The disclosed methodology desirably requires no special optical isolation between LED 125 and sensor 130 to prevent cross-talk between these two structures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
transmitting, by a proximity detector, light to an object thus providing transmitted light;
detecting, by the proximity detector, transmitted light reflected by the object as exceeding a predetermined brightness threshold value, thus providing preliminary object detection; and
testing, by the proximity detector, to determine if there is a substantial decrease in an amount of ambient light detected by the proximity detector as the distance between the object and the proximity detector decreases to confirm object detection.

2. The method of claim 1, further comprising:
discontinuing, by the proximity detector, the transmitting of light from the proximity detector to the object before testing to determine if there is a substantial decrease in the amount of ambient light detected by the proximity detector.

3. The method of claim 1, wherein the transmitted light is infrared light and the ambient light is visible light.

4. The method of claim 1, wherein the transmitted light is infrared light and the ambient light is infrared light.

5. The method of claim 1, wherein the substantial decrease in the amount of ambient light detected by the proximity detector is at least an approximately 50% decrease.

6. The method of 1, further comprising disabling a display in response to confirming object detection.

7. The method of claim 1, further comprising storing reflected light data for use in detecting, by the proximity detector, transmitted light reflected by the object as exceeding a predetermined threshold brightness value.

8. The method of claim 1, further comprising storing ambient light data for use in testing, by the proximity detector, to determine if there is a substantial decrease in an amount of ambient light detected by the proximity detector as the distance between the object and the proximity detector decreases.

9. The method of claim 1, wherein a common sensor detects both the transmitted light reflected by the object and the ambient light for the proximity detector.

10. The method of claim 1, wherein the predetermined threshold brightness value is a count value that the proximity detector generates in response to the transmitted light reflected by the object.

11. The method of claim 1, further comprising:
generating, by the proximity detector, a plurality of reflected light values by sensing transmitted light reflected by the object over a predetermined time interval; and
generating, by the proximity detector, a plurality of ambient light values by sensing ambient light received by the proximity detector over substantial the same predetermined time period.

12. The method of claim 1, further comprising decreasing the distance between the proximity detector and the object, wherein the decreasing includes at least one of moving the proximity detector toward the object and moving the object toward the proximity detector.

13. A proximity detector, comprising:
a light source that transmits light to an object thus providing transmitted light;
a sensor that detects transmitted light reflected by the object when the proximity detector operates in a proximity sensing (PS) mode, the sensor detecting ambient light when the proximity detector operates in an ambient light sensing (ALS) mode; and
a controller, coupled to the light source and the sensor, the controller determining if transmitted light reflected by the object exceeds a predetermined brightness threshold value thus providing preliminary object detection, the controller further determining if there is a substantial decrease in an amount of ambient light detected by the sensor as the distance between the object and the proximity detector decreases to confirm object detection.

14. The proximity detector of claim 13, wherein the light source discontinues transmitting light to the object before the controller determines if there is a substantial decrease in the amount of ambient light detected by the sensor.

15. The proximity detector of claim 13, wherein the transmitted light is infrared light and the ambient light is visible light.

16. The proximity detector of claim 13, wherein the transmitted light is infrared light and the ambient light is infrared light.

17. A portable device, comprising:
a light source that transmits light to an object thus providing transmitted light;
a sensor that detects transmitted light reflected by the object when the proximity detector operates in a proximity sensing (PS) mode, the sensor detecting ambient light when the proximity detector operates in an ambient light sensing (ALS) mode; and
a controller, coupled to the light source and the sensor, the controller determining if transmitted light reflected by the object exceeds a predetermined brightness threshold value thus providing preliminary object detection, the controller further determining if there is a substantial decrease in an amount of ambient light detected by the sensor as the distance between the object and the proximity detector decreases to confirm object detection.

18. The portable communication device of claim 17, wherein the light source discontinues transmitting light to the object before the controller determines if there is a increase in the amount of ambient light detected by the sensor.

19. The portable communication device of claim 17, wherein the substantial decrease in the amount of ambient light determined by the controller is at least an approximately 50% decrease.

20. The portable communication device of claim 17, further comprising a display that displays information and that receives user input, wherein the controller disables the display in response to confirming object detection.
